(19) United States
(12) Patent Application Publication
(10) Pub. No.: US 2023/0214657 A1
(43) Pub. Date: Jul. 6, 2023

(54) METHOD AND APPARATUS FOR INFORMATION FLOW BASED AUTOMATIC NEURAL NETWORK COMPRESSION THAT PRESERVES THE MODEL ACCURACY

(71) Applicant: NOTA, INC., Daejeon (KR)

(72) Inventors: Seul-ki Yeom, Daejeon (KR); Thibault Castells, Daejeon (KR)

(73) Assignee: NOTA, INC., Daejeon (KR)

(21) Appl. No.: 18/056,644

(22) Filed: Nov. 17, 2022

(30) Foreign Application Priority Data
Dec. 31, 2021 (KR) 10-2021-0193714

(51) Int. Cl. G06N 3/08; G06N 3/04

(52) U.S. Cl. CPC G06N 3/082; G06N 3/0454

(57) ABSTRACT

Disclosed is an automatic lightweight method and apparatus for information flow-based neural network compression model that may preserve a performance. An automatic lightweight method for a neural network model may include receiving a first model, generating a second model by injecting trainable bottleneck parameters into the first model, training the bottleneck parameters of the second model using training data, determining an optimal threshold for the trained bottleneck parameters, and pruning the second model based on the trained bottleneck parameters and the determined optimal threshold.

### CROSS-REFERENCE TO RELATED APPLICATION

This application claims the priority benefit of Korean Patent Application No. 10-2021-0193714, filed on Dec. 31, 2021, in the Korean Intellectual Property Office, the disclosure of which is incorporated herein by reference.

### BACKGROUND

### 1. Field of the Invention

The following description of example embodiments relates to an automatic lightweight method and apparatus for information flow-based neural network model that may preserve a performance.

### 2. Description of the Related Art

In the last decade, popularity of deep neural networks (DNNs) has grown exponentially with improvements in method results and the DNNs are now used in a variety of application fields, such as classification, detection, and the like. However, such improvements often face an increasing model complexity, which leads to requiring more computational resources. Therefore, although a hardware performance quickly improves, it is still hard to directly deploy a model into a targeted edge device or a smartphone. To this end, various attempts to make heavy models more compact are proposed based on various compression methods, such knowledge distillation, pruning, quantization, neural architecture search (NAS), and the like. Among such categories, network pruning that removes a redundant and unimportant connection is one of the most popular and promising compression methods and recently receives great interest from the industry that seeks to compress an artificial intelligence (AI) model and fit the same on a small target device with resource constraints. Indeed, being able to run the model on the device instead of using a cloud computing brings numerous advantages, such as reduced cost and energy consumption, increased speed, and data privacy.

Since a process of manually defining a percentage of each layer to be pruned is a time-consuming process that requires human expertise, recent works have proposed methods of automatically pruning a redundant filter throughout a network to meet a given constraint, such as the number parameters, floating point operations per second (FLOPs), and a hardware platform. To automatically find a best-pruned architecture, the above methods rely on various metrics, such as 2^{nd} order Taylor expansion, layer-wise relevance propagation score, and the like. Although such strategies improved over time, the strategies do not explicitly aim to maintain a model accuracy or are performed in a computationally expensive way.

The performance of a neural network has been significantly improved in last few years at the cost of an increasing number of FLOPs. However, more FLOPs may become an issue when computational resources are limited. As an attempt to solve this issue, pruning filters is a common solution, but most existing pruning methods do not preserve the model accuracy efficiently and thus, require a large number of finetuning epochs. For example, most existing methods are computationally and time expensive since the methods either require to retrain a model from scratch, apply iterative pruning, or finetune the model while pruning. When the model is not retrained or finetuned during a pruning process, the methods generally do not maintain the model accuracy after pruning and thus, finetuning is required for a large number of epochs.

A reference material includes Korean Patent Laid-Open Publication No. 10-2020-0115239.

### SUMMARY

Example embodiments provide an automatic lightweight method and apparatus that may learn neurons to preserve in order to maintain a model accuracy while reducing floating point operations per second (FLOPs) to a predefined target.

According to an example embodiment, there is provided an automatic lightweight method performed by a computer device including at least one processor, the method including receiving, by the at least one processor, a first model; generating, by the at least one processor, the second model by injecting trainable bottleneck parameters into the first model; training, by the at least one processor, the bottleneck parameters of the second model; determining, by the at least one processor, an optimal threshold for the trained bottleneck parameters; and pruning, by the at least one processor, the second model based on the trained bottleneck parameters and the determined optimal threshold.

According to an aspect, the automatic lightweight method may further include finetuning, by the at least one processor, the pruned second model using the training data.

According to another aspect, the training the bottleneck parameters may include updating the trainable bottleneck parameters based on a loss of the second model.

According to still another aspect, the loss may include a cross-entropy loss, a first loss designed to satisfy constraints such that all the modules that belong to the same convolution block are pruned, and a second loss designed to force a bottleneck parameter to converge toward a binary solution indicating presence or absence of a filter.

According to still another aspect, the determining the optimal threshold may include estimating floating point operations per second (FLOPs) of the pruned second model without actual pruning by pseudo-pruning the second model based on a threshold.

According to still another aspect, the determining the optimal threshold may include updating the optimal threshold to reduce a distance between current FLOPs of a pseudo-pruned second model and target FLOPs through the dichotomy algorithm when a difference between the current FLOPs and the target FLOPs is greater than or equal to a preset FLOPs error.

According to still another aspect, the updating the optimal threshold may be iteratively performed while the difference between the current FLOPs and the target FLOPs is greater than or equal to the preset FLOPs error.

According to still another aspect, the pruning may include pruning the second model by removing a filter with a trained bottleneck parameter lower than the optimal threshold.

According to still another aspect, the injecting may include injecting the trainable bottleneck parameters and noise into the first model.

According to still another aspect, the injecting may include restricting a trainable parameter layer-wisely by injecting a bottleneck parameter into each convolution block of the first model.

According to an example embodiment, there is provided a non-transitory computer-readable recording medium storing a program to perform the method on a computer device.

According to an example embodiment, there is provided a computer device including at least one processor configured to execute a computer-readable instruction, wherein the at least one processor is configured to receive a first model, to generate a second model by injecting trainable bottleneck parameters into the first model, to train the bottleneck parameters of the second model using training data, to determine an optimal threshold for the trained bottleneck parameters, and to prune the second model based on the trained bottleneck parameters and the determined optimal threshold.

According to some example embodiments, there may be provided an automatic lightweight method and apparatus that may learn neurons to preserve in order to maintain a model accuracy while reducing FLOPs to a predefined target.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a system flow of AutoBot for automatic network pruning according to an example embodiment;

FIG. 2 is a graph showing a per-layer filter pruning ratio for various targeted FLOPs on VGG-16 according to an example embodiment;

FIG. 3 is a graph showing an example of Top-1 accuracy before and after finetuning for various pruning strategies on VGG-16 according to an example embodiment;

FIG. 4 is an example of graphs showing performance comparison results between an original pretrained model and an pruned model according to an example embodiment;

FIG. 5 is a diagram illustrating an example of a computer device according to an example embodiment; and

FIG. 6 is a flowchart illustrating an example of an automatic lightweight method according to an example embodiment.

### DETAILED DESCRIPTION

Hereinafter, example embodiments will be described with reference to the accompanying drawings.

The example embodiments provide an automatic lightweight method and apparatus that may learn neurons to preserve in order to maintain a model accuracy while reducing floating point operations per second (FLOPs) to a predefined target. The automatic lightweight method according to an example embodiment may efficiently learn a bottleneck layer only with a small amount of dataset (25.6% (CIFAR-10) and 7.49% (ILSVRC2012)). The following experiments on various architectures and datasets show that the proposed automatic lightweight method may maintain an accuracy after pruning and also outperform existing methods after finetuning. When achieving 52.00% of lightweight on ResNet-50 model using ILSVRC 2012 dataset, the automatic lightweight method according to an example embodiment shows a most excellent performance among the existing techniques, with a top accuracy of 47.51% after pruning and an accuracy of 76.63% after finetuning.

The automatic lightweight method may be based on hypothesis that a pruned architecture capable of leading to a best accuracy after finetuning is an architecture capable of most efficiently preserving the accuracy during a pruning process. The automatic lightweight method and apparatus according to example embodiments may introduce AutoBot, a novel automatic pruning method that uses a trainable bottleneck to efficiently preserve a model accuracy while minimizing FLOPs based on the hypothesis.

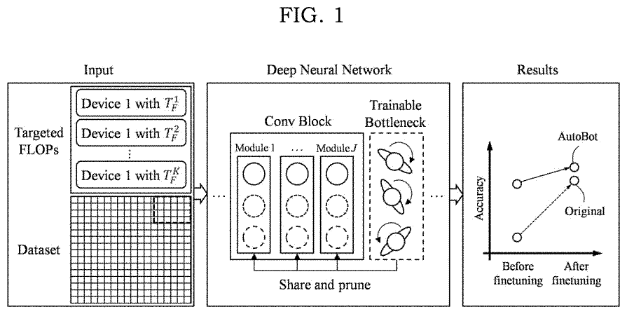

FIG. 1 illustrates an example of a system flow of AutoBot for automatic network pruning according to an example embodiment. The trainable bottleneck may be injected into each convolution block and may be updated by restricting an information flow (e.g., water tap) with given target FLOPs and with a small amount of data. Within each convolution block, trainable parameters may be shared by modules (e.g., convolution and normalization layers). As a result, compared to other existing pruning methods, AutoBot may achieve a good accuracy before as well as after finetuning.

As described above, the bottleneck only requires one single epoch of training with 25.6% (CIFAR-10) or 7.49% (ILSVRC2012) of the dataset to efficiently learn a filter to be removed.

Hereinafter, the new automatic lightweight method that uses the trainable bottleneck to efficiently learn which filter to prune in order to maximize the accuracy while minimizing FLOPs of the model is described. AutoBot may easily and intuitively be implemented regardless of a dataset or a model architecture.

The automatic lightweight method according to example embodiments may efficiently control an information flow of a pretrained network using the trainable bottleneck injected into the model. An objective function of the trainable bottleneck may maximize the information flow from input to output while minimizing a loss by adjusting an amount of information in the model under given constraints. During a training process, parameters of the trainable bottleneck may be updated while all the pretrained parameters of the model are frozen.

Compared to other pruning methods inspired by the information bottleneck, the automatic lightweight method according to example embodiments do not consider compression of mutual information between the input/output and hidden representations in order to evaluate the information flow. Such methods are orthogonal to AutoBot, which explicitly quantifies an amount of information that is passed to a next layer during a forward pass. Also, the automatic lightweight method according to example embodiments optimizes the trainable bottleneck on a fraction of a single epoch only. This AutoBot pruning process may be represented as an algorithm of Table 1.

TABLE 1
Algorithm 1: AutoBot Algorithm

| Input: | pre-trained model ƒ, targeted FLOPs T_{F}, | |
|---|---|---|
| | acceptable FLOPs error ∈, hyper-parameters | |
| | β and γ, number of iterations k | |
| Data: Training data D | | |
| Output: Pruned model ƒ′ | | |
| begin | | |
| \| | Initialization: | |
| \| | Inject Trainable Bottleneck layers in ƒ | |
| \| | Training of A [symbol] | |
| \| | for Batch [symbol] in D[0; k] do | |
| \| | \| | [symbol] ← [symbol] _{CE}(ƒ( [symbol] ; A)) +β [symbol] _{g}(A) +γ [symbol] ₕ(A) |
| \| | \| | A ← Update(A, [symbol] ) |
| \| | end | |
| \| | Looking for optimal threshold [symbol] [symbol] | |
| \| | Initialize [symbol] and ƒlop_{c} | |
| \| | while \|flop_{c} − [symbol] _{F}\| > ∈ do | |
| \| | \| | ƒlop_{c} ← g(A, [symbol] ) |
| \| | \| | Update [symbol] by dichotomy algorithm |

| | |
|---|---|
| \| | end |
| \| | Remove Trainable Bottleneck layers in ƒ |
| \| | ƒ′ ← Prune(ƒ, A, [symbol] ) |
| \| | ƒ′ ← Finetune(ƒ′, D) |
| \| | return ƒ′ |

end

Trainable Bottleneck

The trainable bottleneck refers to a module that may restrict an information flow through the network during the forward pass using trainable parameters, and may be represented as the following Equation 1.

Xᵢ₊₁=B(λᵢ,Xᵢ) [Equation 1]

In Equation 1, B denotes the trainable bottleneck, λᵢ denotes a bottleneck parameter of an i^{th} module, and λᵢ and λᵢ₊₁ denote an input feature map and an output feature map of the bottleneck at the i^{th} module, respectively. For example, an amount of information may be controlled by injecting noise into the model. In this case, B may be expressed as B(λᵢ, Xᵢ)=λᵢXᵢ+(1−λᵢ)∈ and here, ∈ denotes noise.

Also, a general bottleneck that is not limited to only an information theory but may be optimized to satisfy any constraint may be represented as the following Equation 2.

$$\begin{matrix}{min}_{Λ} {ℒ}_{CE} ( 𝒴 , f ( 𝒳 ; Λ ) ) & s . t . r ( Λ ) < 𝒞\end{matrix} \qquad [ Equation 2 ]$$

In Equation 2, [symbol] _{CE} denotes a cross-entropy loss, X and Y denote a model input and a model output, respectively, A denotes a set of bottleneck parameters in the model, r denotes a constraint function, and C denotes a desired constraint.

Pruning Strategy

The trainable bottleneck for automatic network pruning may be proposed. To this end, the bottleneck may be injected into each convolution block throughout the network such that an information flow of an estimation model to be removed is quantified by restricting trainable parameters layer-wisely.

Bottleneck function B(λᵢ,Xᵢ) of Equation 1 does not use noise to control the information flow. The information flow may be represented as the following Equation 3.

Xᵢ₊₁=λᵢXᵢ [Equation 3]

In Equation 3, λᵢ∈[0,1]. Therefore, the range of Xᵢ₊₁ is changing from [∈, Xᵢ] to [0, Xᵢ]. Such a feature may be very intuitively used for pruning that is performed based on an importance. That is, the closer to 0, a corresponding output contains insignificant information and is irrelevant to performing pruning accordingly.

Following the general objective function of the trainable bottleneck (Equation 2), two regularizers g and h may be introduced to obtain the following function of Equation 4.

$${min}_{Λ} {ℒ}_{CE} ( 𝒴 , f ( 𝒳 ; Λ ) ) \\ s . t . g ( Λ ) = {𝒯}_{F} and h ( Λ ) = 0 \qquad [ Equation 4 ]$$

In Equation 4, [symbol] denotes target FLOPs (manually fixed). Although it will be described more in detail below, a role of g is to indicate a constraint for a pruned architecture under [symbol] while h makes the parameter A converge toward a binary value, for example, 0 or 1.

As an evaluation metric, FLOPs may be linked with inference time at all times. Therefore, in the case of running a neural network on a device with limited computational resources, pruning to efficiently reduce the FLOPs is a common solution. The example embodiments may also tightly embrace this rule since it is possible to generate any size of pruned models by constraining the FLOPs according to a targeted device. Formally, given the neural network including a plurality of convolution blocks, the following constraint as expressed by Equation 5 below may be enforced.

$$g ( Λ ) = {{\sum }_{i = 1}}^{L} {{\sum }_{j = 1}}^{{J}_{i}} {g}_{i}^{j} ( {λ}_{i} , {λ}_{i - 1} ) \qquad [ Equation 5 ]$$

In Equation 5, λᵢ denotes a parameter vector at an information bottleneck according to an i^{th} convolution block, gᵢ^{j} denotes a function that computes FLOPs of a j^{th} module of the i^{th} convolution block weighted by λᵢ, L denotes a total number of convolution blocks in the model, and Jᵢ denotes a total number of modules in the i^{th} convolution block. For example, assuming that gᵢ^{j} is for a convolution module without bias and padding, Equation 5 may be simply represented as the following Equation 6.

gᵢ^{j}(λᵢ,λᵢ₋₁)=sum(λᵢ)×sum(λᵢ₋₁)×h×w×k×k [Equation 6]

In Equation 6, h and w denote a height and a width of an output feature map of convolution, respectively, and k denotes a kernel size. All the modules within the i^{th} convolution block may share λᵢ. That is, at a block level, all the modules belonging to the same convolution block may be pruned together.

A key issue of pruning is that finding a redundant filter is a discrete problem. That is, the problem is whether to prune the redundant filter. Here, this problem is manifested by the fact that Λ cannot be binary as an optimization problem may be non-differentiable, indicating that backpropagation may not operate. To solve this issue, the continuous parameter Λ may be forced to converge toward a binary solution indicating presence (=1) or absence (=0) of a filter. This may be the role of the constraint h that may be represented as the following Equation 7.

h(λ)=|Λ−round(Λ)| [Equation 7]

To solve the optimization problem defined in Equation 4, two loss terms [symbol] _{g} and [symbol] ₕ designed to satisfy the constraints g and h from Equation 5 and Equation 7, respectively, may be used. [symbol] _{g} and [symbol] ₕ may be represented as Equation 8 and Equation 9, respectively.

$${ℒ}_{g} = \{ \begin{matrix}\frac{g ( Λ ) - {𝒯}_{F}}{{ℳ}_{F} - {𝒯}_{F}} , & if g ( Λ ) \geq {𝒯}_{F} \\ 1 - \frac{g ( Λ )}{{𝒯}_{F}} , & otherwise\end{matrix} \qquad [ Equation 8 ]$$

In Equation 8, [symbol] _{F} denotes FLOPs of an original model and [symbol] denotes a predefined target FLOPs.

$${ℒ}_{h} = \frac{h ( Λ )}{N} \qquad [ Equation 9 ]$$

In Equation 9, N denotes a total number of parameters. In contrast to g and h, such loss terms may be normalized such that scale of loss may be the same at all times. As a result, for a given dataset, a training parameter may be stable across different architectures. The optimization problem to update the proposed information bottleneck for automatic pruning may be summarized as the following Equation 10.

$${min}_{Λ} {ℒ}_{CE} ( 𝒴 , f ( 𝒳 ; Λ ) ) + β {ℒ}_{g} ( Λ ) + γ {ℒ}_{h} ( Λ ) \qquad [ Equation 10 ]$$

In Equation 10, β and γ denote hyperparameters that indicate relative importance of each objective.

Optimal Threshold

Once the bottleneck is trained, A may be directly used as a pruning criterion. Therefore, a method of quickly finding a threshold under which neurons need to be pruned may be provided. Since weighted FLOPs (Equation 5) may be quickly and accurately computed through the bottleneck, FLOPs of a model to be pruned without actual pruning may be estimated. This may be performed by setting Λ to 0 for a filter to be removed or to 1 otherwise. This process is called pseudo-pruning. To find the optimal threshold, a threshold may be initialized to 0.5 and all filters may be pseudo-pruned with Λ lower than the threshold. Then, weighted FLOPs may be computed and a dichotomy algorithm may be adopted to efficiently minimize a distance between current FLOPs and targeted FLOPs. This process may be repeated until a gap is small enough. Once the optimal threshold is found, all the bottleneck may be removed from the model and all the filters with Λ lower than the optimal threshold may be removed to obtain a compressed model with the targeted FLOPs.

Parameterization

As clipping needs to be used to maintain [0, 1] interval, Λ is not directly optimized. Instead, Λ=sigmoid Ψ in which sigmoid element is present in R may be parameterized and Ψ may be optimized without constraints accordingly.

Reduced Training Data

That training loss for the bottleneck may quickly converge before the end of a first epoch was empirically observed. Therefore, it suggests that, regardless of a model size (i.e., FLOPs), an optimally pruned architecture may be efficiently estimated using only a small portion of a dataset

Experiments

To demonstrate the efficiency of AutoBot on a variety of experimental setups, the experiments are conducted on 1) CIFAR-10 with VGG-16, ResNet-56/110, DenseNet, and GoogLeNet, and 2) ILSVRC2012 (ImageNet) with ResNet-50.

Experiments are performed within the PyTorch and torchvision frameworks under Intel® Xeon® Silver 4210R CPU 2.40 GHz and NVIDIA RTX 2080 Ti with 11 GB for GPU processing.

For CIFAR-10, the bottleneck was trained for 200 iterations with a batch size of 64, a learning rate of 0.6, and β and γ equal to 6 and 0.4, respectively. The model was finetuned for 200 epochs with an initial learning rate of 0.02 scheduled by a cosine annealing scheduler and with a batch size of 256. For ImageNet, the bottleneck was trained for 3000 iterations with a batch size of 32, a learning rate of 0.3, and β and γ equal to 10 and 0.6, respectively. The model was finetuned for 200 epochs with a batch size of 512 and with an initial learning rate of 0.006 scheduled by the cosine annealing scheduler. The bottleneck was optimized via an Adam optimizer. All the networks were retrained via a Stochastic Gradient Descent (SGD) optimizer with momentum of 0.9 and decay factor of 2×10⁻³ for CIFAR-10 and with momentum of 0.99 and decay factor of 1×10⁻⁴ for ImageNet.

Evaluation Metrics

For a quantitative comparison, Top-1 (and Top-5 for ImageNet) accuracy of the models are first evaluated. This comparison is performed after finetuning, as is common in DNN pruning literature. Also, the Top-1 accuracy is measured immediately after a pruning stage (before finetuning) to prove that the automatic lightweight method according to example embodiments may effectively preserve an important filter that has a great impact on a model decision. In deed, accuracy after finetuning depends on many parameters independent from a pruning method, such as data augmentation, a learning rate, a scheduler, and the like. Therefore, it may not be a most accurate way to compare performance across pruning methods.

Therefore, commonly used metrics are adopted. FLOPs and the number of parameters are used to measure quality of a pruned model in terms of computational efficiency and a model size. The automatic lightweight method according to example embodiments may freely compress a pretrained model in any size with the give target FLOPs.

Automatic Pruning on CIFAR10

To demonstrate the improvement of the method disclosed herein, automatic pruning is initially performed with some of the most popular convolutional neural networks, for example, VGG-16, ResNet-56/110, GoogLeNet, and DenseNet-40. The following Table 2 shows experimental results with such architectures on CIFAR-10 for various numbers of FLOPs.

TABLE 2

| | | Top1-acc | | | FLOP3 | | Params | |
|---|---|---|---|---|---|---|---|---|
| Method | Automatic | before finetuning | Top1-acc | ↑ ↓ | (Pruning Ratio) | | (Pruning Ratio) | |
| VGG-16 | | — | 93.96% | 0.0% | 314.29M | (0.0%) | 14.99M | (0.0%) |
| L1 | | 88.70%* | 93.40% | −0.56% | 206.00M | (34.5%) | 5.40M | (64.0%) |
| CC-0.4 | ✓ | — | 94.15% | +0.19% | 154.00M | (51.0%) | 5.02M | (66.5%) |
| AutoBot | ✓ | 88.29% | 94.19% | +0.23% | 145.61M | (53.7%) | 7.53M | (49.8%) |
| CC-0.5 | ✓ | — | 94.00% | +0.13% | 123.00M | (60.9%) | 5.02M | (73.2%) |
| HRank-65 | | 10.00%** | 92.34% | −1.62% | 108.61M | (65.4%) | 2.64M | (82.4%) |
| AutoBot | ✓ | 82.73% | 94.01% | +0.05% | 108.7M | (65.4%) | 6.44M | (57.0%) |
| ITPruner | ✓ | — | 94.00% | +0.04% | 98.80 | (68.6%) | — | |
| ABCPruner | ✓ | — | 93.08% | −0.88% | 82.81M | (73.7%) | 1.67M | (88.9%) |
| DCPF | | — | 93.49% | −0.47% | 72.77M | (76.8%) | 1.06M | (92.9%) |
| AutoBot | ✓ | 71.24% | 93.62% | −0.34% | 72.60M | (76.9%) | 5.51M | (63.24%) |
| VIBNet | ✓ | — | 91.50% | −2.46% | 70.63M | (77.5%) | — (94.7%) | |
| ResNet-56 | | — | 93.27% | 0.0% | 126.55M | (0.0%) | 0.85M | (0.0%) |
| L1 | | — | 93.06% | −0.21% | 90.90M | (28.2%) | 0.73M | (14.1%) |
| HRank-50 | | 10.78%** | 93.17% | −0.10% | 62.72M | (50.4%) | 0.49M | (42.4%) |
| SCP | | — | 93.23% | −0.04% | 61.89M | (51.1%) | 0.44M | (48.2%) |
| CC | ✓ | — | 93.64% | +0.37% | 60.00M | (52.6%) | 0.44M | (48.2%) |
| ITPruner | ✓ | — | 93.43% | +0.16% | 59.50 | (53.0%) | — | |
| FPGM | | — | 93.26% | −0.01% | 59.40M | (53.0%) | — | |
| LFPC | | — | 93.24% | −0.03% | 50.10M | (53.3%) | — | |
| ABCPruner | ✓ | — | 93.23% | −0.04% | 58.54M | (53.7%) | 0.39M | (54.1%) |
| DCFF | | — | 93.26% | −0.01% | 55.84M | (559%) | 0.38M | (55.3%) |
| AutoBot | ✓ | 85.58% | 93.76% | +0.49% | 55.82M | (55.9%) | 0.46M | (45.9%) |
| SCOP | | — | 93.46% | +0.37% | — (56.0%) | | — (56.3%) | |
| ResNet-110 | | — | 93.5% | 0.0% | 254.98M | (0.0%) | 1.73M | (0.0%) |
| L1 | | — | 93.30% | −0.20% | 155.00M | (39.2%) | 1.16M | (32.9%) |
| HRank-58 | | — | 93.36% | −0.14% | 105.70M | (58.5%) | 0.70M | (59.5%) |
| LPPC | | — | 93.07% | −0.43% | 101.00M | (60.3%) | — | |
| ABCPruner | ✓ | — | 93.58% | +0.08% | 89.87M | (64.8%) | 0.56M | (67.6%) |
| DCFF | | — | 93.80% | +0.30% | 85.30M | (66.5%) | 0.56M | (67.6%) |
| AutoBot | ✓ | 84.37% | 94.15% | +0.65% | 85.28M | (66.6%) | 0.70M | (59.5%) |
| GoogLeNet | | — | 95.05% | 0.0% | 1.53B | (0.0%) | 6.17M | (0.0%) |
| L1 | | — | 94.54% | −0.51% | 1..02B | (33.3%) | 3.51M | (43.1%) |
| Random | | — | 94.54% | −0.51% | 0.96B | (37.3%) | 3.58M | (42.0%) |
| HRank-54 | | — | 94.53% | −0.52% | 0.69B | (54.9%) | 2.74M | (55.6%) |
| CC | ✓ | — | 94.88% | −0.17% | 0.61M | (60..1%) | 2.26M | (63.4%) |
| ABCPruner | ✓ | — | 94.84% | −0.21% | 0.51B | (66.7%) | 2.46M | (60.1%) |
| DCFF | | — | 94.92% | −0.13% | 0.46B | (69.9%) | 2.08M | (66.3%) |
| HRank-70 | | 10.00%** | 94.07% | −0.98% | 0.45B | (70.6%) | 1.86M | (69.9%) |
| AutoBot | ✓ | 90.18% | 95.23% | +0.16% | 0.45B | (70.6%) | 1.66M | (73.1%) |
| DenseNet-40 | | — | 94.81% | 0.0% | 287.71M | (0.0%) | 1.06M | (0.0%) |
| Network | ✓ | — | 94.81% | −0.00% | 190.00M | (34.0%) | 0.66M | (37.7%) |
| Slimming | | | | | | | | |
| GAL-0.01 | | — | 94.29% | −0.52% | 182.92M | (36.4%) | 0.67M | (36.8%) |
| AutoBot | ✓ | 87.85% | 94.67% | −0.14% | 167.64M | (41.7%) | 0.76M | (28.3%) |
| HRank-40 | | 25.58%** | 94.24% | −0.57% | 167.41M | (41.8%) | 0.66M | (37.7%) |
| Variational | | — | 93.16% | −1.65% | 156.00M | (45.8%) | 0.42M | (60.4%) |
| CNN | | | | | | | | |
| AutoBot | ✓ | 83.20% | 94.41% | −0.4% | 128.25M | (55.4%) | 0.62M | (41.5%) |
| GAL-0.05 | | — | 93.53% | −1.28% | 128.11M | (55.5%) | 0.45M | (57.5%) |

Table 2 shows arrangement results of five network architectures on CIFAR-10, sorted by FLOPs in descending order. Scores in brackets represent a pruning ratio in compressed models.

Pruning was performed on the VGG-16 architecture with three different pruning ratios. VGG-16 is a very common convolutional neural network architecture that includes 13 convolution layers and two fully-connected layers. Table 2 shows that the automatic lightweight method according to example embodiments may maintain a relatively higher accuracy before finetuning even under the same FLOPs reduction (e.g., 82.73% (proposed method) vs 10.00% (HRANK) for 65.4% of FLOPs reduction), thus leading to a SOT accuracy after finetuning. For example, when reducing the FLOPs by 76.9%, an accuracy of 71.24% and 93.62% before and after finetuning are obtained, respectively. The automatic lightweight method according to example embodiments outperforms a baseline by 0.05% and 0.23% when reducing the FLOPs by 65.4% and 53.7%, respectively.

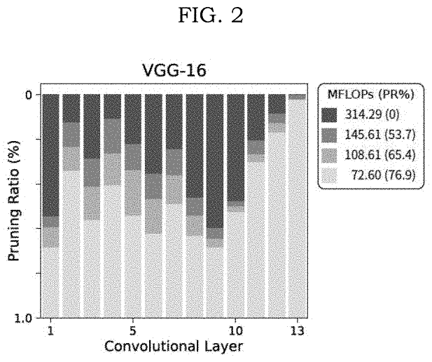

FIG. 2 is a graph showing a per-layer filter pruning ratio for various targeted FLOPs on VGG-16 according to an example embodiment. Referring to FIG. 2, the per-layer pruning layer may be automatically determined by AutoBot according to the target FLOPs.

GoogLeNet is a large architecture (1.53 billion parameters) characterized by its parallel branches named inception blocks, and includes a total of 64 convolution layers and a single fully-connected layer. An accuracy of 90.18% after pruning under FLOPs reduction of 70.6% leads to the SOTA accuracy of 95.23% after finetuning, outperforming recent papers, such as DCFF and CC. Also, although it is not a primary focus of the automatic lightweight method according to example embodiments, the automatic lightweight method may achieve a significant improvement in terms of parameters reduction (73.1%).

ResNet is an architecture characterized by its residual connections. The automatic lightweight method according to example embodiments adopts ResNet-56 including 55 convolution layers and ResNet-110 including 109 convolution layers. The pruned model using the automatic lightweight method according to example embodiments may improve the accuracy from 85.58% before finetuning to 93.76% after finetuning under FLOPs reduction for ResNet-56, and may improve the accuracy from 84.37% before finetuning to 94.15% after finetuning under FLOPs reduction for ResNet-110. Under similar or even smaller FLOPs, the automatic lightweight method according to example embodiments accomplishes an excellent Top-1 accuracy compared to other existing magnitude-based or adaptive-based pruning methods and outperforms the performance of a baseline model (93.27% for ResNet-56 and 93.50% for ResNet-110).

DenseNet-40 is an architecture based on residual connections and includes 39 convolution layers and a single fully-connected layer. Experiments were performed using two different target FLOPs as shown in Table 2. In particular, an accuracy of 83.2% before finetuning and an accuracy of 94.41% after finetuning under FLOPs reduction of 55.4% were obtained.

Automatic Pruning on ImageNet

To show the performance of the automatic lightweight method according to example embodiments on ILSVRC-2012, the ResNet-50 architecture that includes 53 convolution layers and a fully-connected layer was selected. Due to the complexity of this dataset (1,000 classes and millions of images) and the compact design of ResNet itself, this task is more challenging than the compression of models on CIFAR-10. While existing pruning methods that need to manually define a pruning ratio for each layer achieve reasonable performance, global pruning according to the automatic lightweight method according to example embodiments allows competitive results in all evaluation metrics that include Top-1 and Top-5 accuracy, FLOPs reduction, and reduction in the number of parameters, as shown in Table 3.

TABLE 3

| | | Top1-acc | | | | | FLOP5 | | Params | |
|---|---|---|---|---|---|---|---|---|---|---|
| Method | Automatic | before finetuning | Top1-acc | ↑ ↓ | Top5-acc | ↑ ↓ | (Pruning Ratio) | | (Pruning Ratio) | |
| ResNet-50 | | — | 76.13% | 0.0% | 92.87% | 0.0% | 4.11B | (0.0%) | 25.56M | (0.0%) |
| ThiNe-50 | | — | 72.04% | −4.09% | 90.67% | −2.20% | — (36.8%) | | — (33.72%) | |
| PPGM | | — | 75.59% | −0.59% | 92.27% | −0.60% | 2.55B | (37.5%) | 14.74M | (42.3%) |
| ABCPruner | ✓ | — | 74.84% | −1.29% | 92.31% | −0.56% | 2.45B | (40.8%) | 16.92M | (33.8%) |
| SFP | | — | 74.61% | −1.52% | 92.06% | −0.81% | 2.38B | (41.8%) | — | |
| HRank-74 | | — | 74.98% | −1.15% | 92.33% | −0.54% | 2.30B | (43.7%) | 16.15M | (36.8%) |
| Taylor | | — | 74.50% | −1.63% | — | — | — (44.5%) | | (44.9%) | |
| DCFF | | — | 75.18% | −0.95% | 92.56% | −0.31% | 2.25B | (45.3%) | 15.16M | (40.7%) |
| ITPruner | ✓ | — | 75.75% | −0.38% | — | — | 2.23B | (45.7%) | — | |
| AutoPruner | ✓ | — | 74.76% | −1.37% | 92.15% | −0.72% | 2.09B | (48.7%) | — | |
| RRBP | | — | 73.00% | −3.13% | 91.00% | −1.87% | — | | — (54.5%) | |
| AutoBot | ✓ | 47.51% | 76.63% | +0.50% | 92.95% | +0.08% | 1.97B | (52.0%) | 16.73M | (34.5%) |
| ITPruner | ✓ | — | 75.28% | −0.85% | — | — | 1.94B | (52.8%) | — | |
| GDP-0.6 | ✓ | — | 71.19% | −4.94% | 90.71% | −2.16% | 1.88B | (34.0%) | — | |
| SCOP | | — | 75.26% | −0.87% | 92.53% | −0.33% | 1.85B | (54.6%) | 12.29M | (51.9%) |
| GAL-0.5-joint | | — | 71.80% | −4.33% | 90.82% | −2.05% | 1.84B | (55.0%) | 19.31M | (24.5%) |
| ABCPruner | ✓ | — | 75.52% | −2.61% | 91.51% | −1.36% | 1.79B | (56.6%) | 11.24M | (56.0%) |
| GAL-1 | | — | 69.88% | −6.25% | 89.75% | −3.12% | 1.58B | (61.3%) | 14.67M | (42.6%) |
| LFPC | | — | 74.18% | −1.95% | 91.92% | −0.95% | 1.60B | (61.4%) | — | |
| GDP-0.5 | ✓ | — | 69.58% | −6.55% | 90.14% | −2.73% | 1.57B | (61.6%) | — | |
| DCFF | | — | 75.60% | −0.53% | 92.55% | −0.32% | 1.52B | (63.0%) | 11.05M | (56.8%) |
| DCFF | | — | 74.85% | −1.28% | 92.41% | −0.46% | 1.38B | (66.7%) | 11.81M | (53.8%) |
| AutoBot | ✓ | 14.71% | 74.68% | −1.45% | 92.20% | −0.66 % | 1.14B | (72.3%) | 9.93M | (61.2%) |
| GAL-1-joint | | — | 69.31% | −6.82% | 89.12% | −3.75% | 1.11B | (72.8%) | 10.21M | (60.1%) |
| CURL | ✓ | — | 73.39% | −2.74% | 91.46% | −1.41% | 1.11B | (73.2%) | 6.67M | (73.9%) |
| DCFF | | — | 73.81% | −2.32% | 91.59% | −1.28% | 1.02B | (75.1%) | 6.56M | (74.3%) |

Under the high FLOPs compression of 72.3%, the automatic lightweight method according to example embodiments obtains an accuracy of 74.68%, outperforming recent works including GAL (69.31%) and CURL (73.39%) with a similar compression. Under the reasonable compression of 52%, the automatic lightweight method according to example embodiments even outperforms the baseline by 0.5% and, in this manner, outperforms all the previous methods by at least 1%. Therefore, the proposed method also works well on a complex dataset.

Ablation Study

To highlight the impact of preserving the accuracy during the pruning process, the accuracy before and after finetuning of AutoBot may be compared to different pruning strategies.

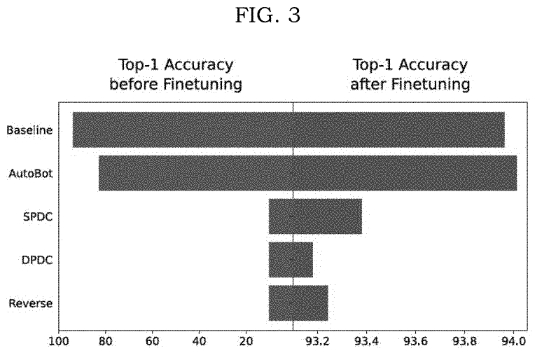

FIG. 3 is a graph showing an example of Top-1 accuracy before and after finetuning for various pruning strategies on VGG-16 according to an example embodiment. To show the superiority of an architecture found by maintaining the accuracy compared to a manually designed architecture, a comparison study was conducted by manually designing three strategies: 1) Same Pruning, Different Channels (SPDC), 2) Different Pruning, Different Channels (DPDC), and 3) Reverse.

DPDC has the same FLOPs as the architecture found by AutoBot, but uses a different per-layer pruning ratio. To show the impact of bad initial accuracy for finetuning, proposed is the SPDC strategy that has the same per-layer pruning ratio as the architecture found by AutoBot but uses a randomly selected filter. Also, the automatic lightweight method according to example embodiments proposes to reverse the order of importance of filters selected by AutoBot such that only a less important filter may be removed. In this manner, the automatic lightweight method according to example embodiments may better appreciate the importance of scores returned by AutoBot. In FIG. 3, this strategy is defined as Reverse. Note that this strategy provides a different per-layer pruning ratio than the architecture found by AutoBot. The automatic lightweight method according to example embodiments evaluates three strategies on VGG-16 with a pruning ratio of 65.4% and uses the same finetuning condition for all the strategies. The automatic lightweight method according to example embodiments selects a best accuracy among three runs. Referring to FIG. 3, while the DPDC strategy provides an accuracy of 93.18% after finetuning, the SPDC strategy displays an accuracy of 93.38%, thus showing that an architecture found by preserving the initial accuracy provides better performance. Also, the Reverse strategy obtains 93.24%, which is surprisingly better than the hand-made architecture, but, as expected, underperforms the architecture found by AutoBot although the SPDC strategy is applied.

Deployment Test

To highlight the improvement in real situations, compressed models need to be tested on edge AI devices. Therefore, a comparison on the inference speed-up of compressed networks deployed on GPU-based (NVIDIA Jetson Nano) and CPU-based (Raspberry Pi 4, Raspberry Pi 3, Raspberry Pi 2) edge devices is performed. The following Table 4 show specifications of the devices.

TABLE 4

| Platform | CPU | GPU | Memory |
|---|---|---|---|
| Jetson-Nano | Quad core | 128-core | 4 GB |
| | Cortex-A57 @ | Maxwells ™ μA | LPDDR4 |
| | 1.43 GHz | | |
| Raspberry Pi 4B | Quad core | No GPGPU | 4 GB |
| | Cortex-A72 @ | | LPDDR4 |
| | 1.5 GHz | | |
| Raspberry Pi 3B+ | Quad core | No GPGPU | 1 GB |
| | Cortex-A53 @ | | LPDDR2 |
| | 1.4 GHz | | |
| Raspberry Pi 2B | Quad core | No GPGPU | 1 GB |
| | Cortex-A7 @ | | SDRAM |
| | 900 MHz | | |

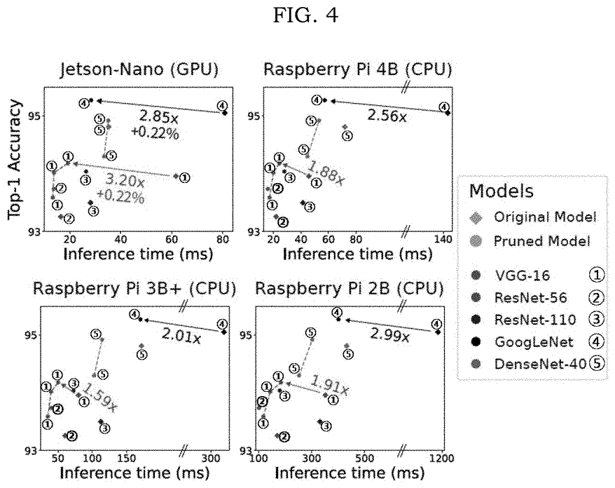

The arranged models may be converted into ONNX format. FIG. 4 is an example of graphs showing performance comparison results between an original pretrained model and a compressed model according to an example embodiment. Performance comparison results between an original model and a removed model (a pruned model) are shown in terms of accuracy (x-axis) and inference time (ms) (y-axis) using five different networks on CIFAR-10. In the graphs, the left upper end may represent better performance. The automatic lightweight method according to example embodiments shows that inference time for pruned models is improved in every target edge device. For example, GoogleNet is 2.85× faster on Jetson-Nano and 2.56× faster on Raspberry Pi 4B while the accuracy improved by 0.22%. In particular, the speed is significantly better on GPU-based devices for single sequence of layers models (e.g., VGG-16 and GoogLeNet), whereas the speed improved most on CPU-based devices for models with skip connections. More detailed results are available in the following Table 5.

TABLE 5

| | | Hardware (Processor) | | | |
|---|---|---|---|---|---|
| Model | FLOPS | Jetson-Nano (GPU) | Raspberry Pi 4B (CPL) | Raspberry Pi 3B+ (CPU) | Raspberry Pi 2B (CPU) |
| VGG-16 | 73.71M | 61.63 → 13.33 (×4.62) | 45.73 → 17.16 (×2.66) | 79.98 → 35.17 (×2.27) | 351.77 → 118.36 (×2.97) |
| VGG-16 | 108.61M | 61.63 → 13.77 (×4.48) | 45.73 → 19.95 (×2.29) | 79.98 → 39.99 (×2.00) | 351.77 → 143.95 (×2.44) |
| VGG-16 | 145.55M | 61.63 → 19.24 (×3.20) | 45.73 → 24.33 (×1.88) | 79.98 → 50.27 (×1.59) | 351.77 → 184.47 (×1.91) |
| ResNet-56 | 55.94M | 16.47 → 13.71 (×1.20) | 21.95 → 15.88 (×1.38) | 60.42 → 39.78 (×1.52) | 170.46 → 101.70 (×1.68) |
| ResNet-110 | 85.30M | 28.10 → 26.36 (×1.07) | 41.35 → 27.90 (×1.48) | 112.57 → 72.71 (×1.55) | 331.60 → 179.01 (×1.84) |
| GoogLeNet | 0.45B | 80.84 → 28.37 (×2.85) | 146.68 → 57.25 (×2.56) | 342.23 → 170.17 (×2.01) | 1,197.65 → 400.89 (×2.99) |
| DenseNet-40 | 129.13M | 35.25 → 33.46 (×1.05) | 71.87 → 44.73 (×1.61) | 171.86 → 102.75 (×1.67) | 432.03 → 252.63 (×1.71) |
| DesseNet-40 | 168.26M | 35.25 → 35.11 (×1.00) | 71.87 → 53.08 (×1.35) | 171.86 → 114.37 (×1.50) | 432.03 → 302.49 (×1.43) |

Table 5 shows an example of deployment test results on various hardware platforms with an arranged model. Here, a numeral value before “→” represents inference time for an original model (ms) and a numerical value after “→” represents inference time for an arranged model (ms).

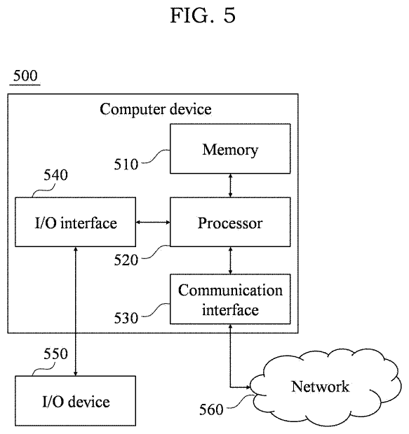

FIG. 5 is a diagram illustrating an example of a computer device according to an example embodiment. A computer device 500 may implement the aforementioned automatic lightweight apparatus and, referring to FIG. 5, may include a memory 510, a processor 520, a communication interface 530, and an input/output (I/O) interface 540. The memory 510 may include a permanent mass storage device, such as a random access memory (RAM), a read only memory (ROM), and a disk drive, as a non-transitory computer-readable recording medium. Here, the permanent mass storage device, such as a ROM and a disk drive, may be included in the computer device 500 as a permanent storage device separate from the memory 510. Also, an OS and at least one program code may be stored in the memory 510. Such software components may be loaded to the memory 510 from another non-transitory computer-readable recording medium separate from the memory 510. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 510 through the communication interface 530, instead of the non-transitory computer-readable recording medium. For example, the software components may be loaded to the memory 510 of the computer device 500 based on a computer program installed by files received over a network 560.

The processor 520 may be configured to process instructions of a computer program by performing basic arithmetic operations, logic operations, and I/O operations. The computer-readable instructions may be provided by the memory 510 or the communication interface 530 to the processor 520. For example, the processor 520 may be configured to execute received instructions in response to a program code stored in a storage device, such as the memory 510.

The communication interface 530 may provide a function for communication between the communication device 500 and another apparatus, for example, the aforementioned storage devices. For example, the processor 520 of the computer device 500 may forward a request or an instruction created based on a program code stored in the storage device such as the memory 510, data, and a file, to other apparatuses over the network 560 under control of the communication interface 530. Inversely, a signal, an instruction, data, a file, etc., from another apparatus may be received at the computer device 500 through the communication interface 530 of the computer device 500. For example, a signal, an instruction, data, etc., received through the communication interface 530 may be forwarded to the processor 520 or the memory 510, and a file, etc., may be stored in a storage medium, for example, the permanent storage device, further includable in the computer device 500.

The I/O interface 540 may be a device used for interfacing with an I/O device 550. For example, an input device may include a device, such as a microphone, a keyboard, a mouse, etc., and an output device may include a device, such as a display, a speaker, etc. As another example, the I/O interface 540 may be a device for interfacing with an apparatus in which an input function and an output function are integrated into a single function, such as a touchscreen. The I/O device 550 may be configured as a single apparatus with the computer device 500.

Also, according to other example embodiments, the computer device 500 may include a greater or smaller number of components than the number of components of FIG. 5. However, there is no need to clearly illustrate many conventional components. For example, the computer device 500 may be configured to include at least a portion of the I/O device 550 or may further include other components, such as a transceiver and a database.

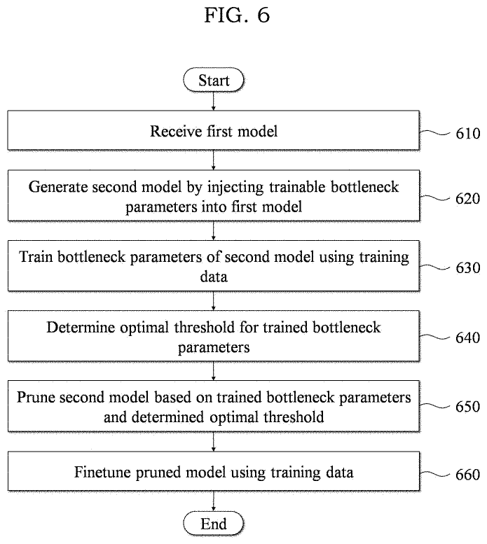

FIG. 6 is a flowchart illustrating an example of an automatic lightweight method according to an example embodiment. The automatic lightweight method according to the example embodiment may be performed by the computer device 500 that implements the aforementioned automatic lightweight apparatus. Here, the processor 520 of the computer device 500 may be configured to execute a control instruction according to a code of at least one computer program or a code of an OS included in the memory 510. Here, the processor 520 may control the computer device 500 to perform operations 610 to 670 included in the method of FIG. 6 according to a control instruction provided from a code stored in the computer device 500.

Referring to FIG. 6, in operation 610, the computer device 500 may receive a first model. For example, a first model may be a model pretrained using training data D.

In operation 620, the computer device 500 may generate a second model by injecting trainable bottleneck parameters into the first model. Here, the trainable bottleneck parameters may be included in trainable bottleneck layer. For example, the computer device 500 may restrict a trainable parameter layer-wisely by injecting a bottleneck parameter into each convolution block of the first model. Here, as an example, it is described that an amount of information may be adjusted by injecting noise into the model. In this case, as described above, the bottleneck B may be represented as B(λᵢ,Xᵢ)=λᵢXᵢ+(1λᵢ)∈.

In operation 630, the computer device 500 may train the bottleneck parameters of the second model using training data. Here, the training data may include the training data D. For example, the computer device 500 may update the trainable bottleneck parameters based on a loss of the second model. Here, the loss may include a cross-entropy loss, a first loss designed to satisfy constraints such that all the modules that belong to the same convolution block are pruned, and a second loss designed to force a bottleneck parameter to converge toward a binary solution indicating presence or absence of a filter. For example, the cross-entropy loss is described above through Equation 2 and the first loss and the second loss are described through Equation 8 and Equation 9, respectively.

In operation 640, the computer device 500 may determining an optimal threshold for the trained bottleneck parameters. For example, the computer device 500 may determine the optimal threshold based on a dichotomy algorithm. And the computer device 500 may estimate FLOPs of the pruned second model without actual pruning by pseudo-pruning the second model based on a threshold. As a more specific example, the computer device 500 may estimate FLOPs of the pruned second model by setting the bottleneck parameters to 0 or 1 for a filter to be removed through bottleneck through the bottleneck layer. When a difference between current FLOPs and target FLOPs is greater than or equal to a preset FLOPs error, the computer device 500 may update the optimal threshold to reduce a distance between the current FLOPs and the target FLOPs through the dichotomy algorithm. Here, the computer device 500 may iteratively update the optimal threshold while the difference between the current FLOPs and the target FLOPs is greater than or equal to the preset FLOPs error.

In operation 650, the computer device 500 may prune the second model based on the trained bottleneck parameters and the determined optimal threshold. For example, the computer device 500 may prune the second model by removing a filter with a trained bottleneck parameter lower than the optimal threshold.

In operation 660, the computer device 500 may finetune the pruned model using the training data. Here, the training data may be the aforementioned training data D.

According to some example embodiments, there may be provided an automatic lightweight method and apparatus that may learn neurons to preserve in order to maintain a model accuracy while reducing FLOPs to a predefined target.

The systems and/or apparatuses described herein may be implemented using hardware components, software components, and/or a combination thereof. For example, apparatuses and components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of the program instructions include a machine language code such as produced by a compiler and an advanced language code executable by a computer using an interpreter.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An automatic lightweight method performed by a computer device comprising at least one processor, the method comprising:
receiving, by the at least one processor, a first model;
generating, by the at least one processor, a second model by injecting trainable bottleneck parameters into the first model;
training, by the at least one processor, the bottleneck parameters of the second model using training data;
determining, by the at least one processor, an optimal threshold for the trained bottleneck parameters; and
pruning, by the at least one processor, the second model based on the trained bottleneck parameters and the determined optimal threshold.

2. The method of claim 1, further comprising:
finetuning, by the at least one processor, the pruned second model using the training data.

3. The method of claim 1, wherein the training the bottleneck parameters comprise updating the trainable bottleneck parameters based on a loss of the second model.

4. The method of claim 3, wherein the loss includes a cross-entropy loss, a first loss designed to satisfy constraints such that all the modules that belong to the same convolution block are pruned, and a second loss designed to force a bottleneck parameter to converge toward a binary solution indicating presence or absence of a filter.

5. The method of claim 1, wherein the determining the optimal threshold comprises estimating floating point operations per second (FLOPs) of the pruned second model without actual pruning by pseudo-pruning the second model based on a threshold.

6. The method of claim 1, wherein the determining the optimal threshold comprises updating the optimal threshold to reduce a distance between current FLOPs of a pseudo-pruned second model and target FLOPs through the dichotomy algorithm when a difference between the current FLOPs and the target FLOPs is greater than or equal to a preset FLOPs error.

7. The method of claim 6, wherein the updating the optimal threshold is iteratively performed while the difference between the current FLOPs and the target FLOPs is greater than or equal to the preset FLOPs error.

8. The method of claim 1, wherein the pruning comprises pruning the second model by removing a filter with a trained bottleneck parameter lower than the optimal threshold.

9. The method of claim 1, wherein the injecting comprises injecting the trainable bottleneck parameters and noise into the first model.

10. The method of claim 1, wherein the injecting comprises restricting a trainable parameter layer-wisely by injecting a bottleneck parameter into each convolution block of the first model.

11. A non-transitory computer-readable recording medium storing a program to perform the method of claim 1 on a computer device.

12. A computer device comprising:
at least one processor configured to execute a computer-readable instruction, wherein the at least one processor is configured to,
receive a first model,
generating a second model by injecting trainable bottleneck parameters into the first model,
train the bottleneck parameters of the second model using training data,
determining an optimal threshold for the trained bottleneck parameters,
prune the second model based on the trained bottleneck parameters and the determined optimal threshold.

13. The computer device of claim 12, wherein the at least one processor is configured to finetune the pruned second model using the training data.

14. The computer device of claim 12, wherein, to train the bottleneck parameters, the at least one processor is configured to update the trainable bottleneck parameters based on a loss of the second model.

15. The computer device of claim 14, wherein the loss includes a cross-entropy loss, a first loss designed to satisfy constraints such that all the modules that belong to the same convolution block are pruned, and a second loss designed to force a bottleneck parameter to converge toward a binary solution indicating presence or absence of a filter.

16. The computer device of claim 12, wherein, to determine the optimal threshold, the at least one processor is configured to estimate floating point operations per second (FLOPs) of the pruned model without actual pruning by pseudo-pruning the second model based on a threshold.

17. The computer device of claim 12, wherein, to determine the optimal threshold, the at least one processor is configured to update the optimal threshold to reduce a distance between current FLOPs of a pseudo-pruned second model and target FLOPs through the dichotomy algorithm when a difference between the current FLOPs and the target FLOPs is greater than or equal to a preset FLOPs error.

18. The computer device of claim 17, wherein the updating the optimal threshold is iteratively performed while the difference between the current FLOPs and the target FLOPs is greater than or equal to the preset FLOPs error.

19. The computer device of claim 12, wherein, to prune the second model the at least one processor is configured to prune the second model by removing a filter with a trained bottleneck parameter lower than the optimal threshold.

20. The computer device of claim 12, wherein, to inject the trainable bottleneck parameters, the at least one processor is configured to inject the trainable bottleneck parameters and noise into the first model.
